(19) United States
(12) Patent Application Publication
(10) Pub. No.: US 2026/0196097 A1
(43) Pub. Date: Jul. 9, 2026

(54) Compliance Gated Event Contract Platform for Sports and Other Events with Integrity Settlement, Risk Controls, and Auditability

(71) Applicant: Barry Itskovitch, Sunny Isles Beach, FL (US)

(72) Inventor: Barry Itskovitch, Sunny Isles Beach, FL (US)

(21) Appl. No.: 19/438,596

(22) Filed: Jan. 1, 2026

Related U.S. Application Data
(60) Provisional application No. 63/741,905, filed on Jan. 5, 2025.
(60) Provisional application No. 63/943,774, filed on Dec. 18, 2025.

(51) Int. Cl. G07F 17/32; G06Q 50/34; H04L 9/00; H04L 9/32; H04W 4/021

(52) U.S. Cl. CPC G07F 17/3241; G06Q 50/34; G07F 17/3239; G07F 17/3288; H04L 9/3297; H04L 9/50; H04W 4/021

(57) ABSTRACT

A computerized platform is disclosed for offering event-based outcome contracts, including sports event contracts, while dynamically enforcing jurisdictional eligibility, integrity-scored settlement, and adaptive risk controls. The platform computes an eligibility vector per user and product class using geo-location signals with anti-spoof checks, identity and account attributes, and versioned jurisdiction rules that can incorporate time-varying legalization indicators and exclusion geofences. The system automatically enables, disables, or sunsets classes of contracts in a jurisdiction when predicates change, and records eligibility decisions with ruleset identifiers in an append-only audit log. Event outcomes are determined via multi-source data ingestion with anomaly detection and integrity scoring, including a provisional outcome, challenge window, dispute workflow, and final cash settlement. A risk engine enforces position and exposure limits, throttles, and kill-switch triggers, and a surveillance module flags manipulation patterns. A regulator export interface supports post-trade reconstruction.

### CROSS-REFERENCE TO RELATED APPLICATIONS

This application claims the benefit of U.S. Provisional Patent Application No. 63/741,905 , filed Jan. 5, 2025. This application further claims the benefit of U.S. Provisional Patent Application No. 63/943,774 , filed Dec. 18, 2025, titled “Systems and Methods for Event-Linked Contract Trading with Jurisdictional Gating, Settlement Integrity, and Risk Controls.” Each of the foregoing is incorporated by reference in its entirety.

### STATEMENT REGARDING FEDERALLY SPONSORED RESEARCH

Not applicable.

### REFERENCE TO A SEQUENCE LISTING

Not applicable.

### TECHNICAL FIELD

The disclosure relates to computerized systems for offering and restricting event-based outcome contracts, including sports event contracts, and to compliance gating, settlement integrity, risk controls, and auditability for such contracts. Implementations may include blockchain-supported recordkeeping.

### BACKGROUND

Sports engagement platforms and prediction mechanisms have historically been implemented as sportsbooks or fantasy contests. Separately, financial markets offer derivatives and binary options. When sports event contracts are offered to retail users, operators face a unique set of constraints: jurisdictional eligibility varies by geography and can change over time; event outcomes must be finalized with strong integrity and dispute handling; and thin liquidity and discontinuous payoffs increase manipulation and concentration risk. Conventional architectures do not provide a unified, auditable stack for (i) dynamic product availability by jurisdiction, (ii) integrity-scored settlement with challenge windows, and (iii) adaptive risk controls and surveillance tuned to event contracts.

### SUMMARY

Systems and methods are disclosed for operating an event contract platform that: (a) determines user eligibility and product availability using geo-location, user attributes, and versioned jurisdiction rules; (b) automatically enables or disables classes of event contracts (including sports event contracts) as legal predicates change; (c) determines outcomes via multi-source ingestion with integrity scoring and dispute workflows; (d) enforces adaptive risk limits and market surveillance; and (e) generates tamper-evident audit logs that support regulatory reporting and post-trade reconstruction.

### BRIEF DESCRIPTION OF THE DRAWINGS

FIG. 1 illustrates a system architecture of an event contract platform.

FIG. 2 illustrates user onboarding, identity verification, and geo-location verification.

FIG. 3 illustrates eligibility evaluation and product availability feature-flagging.

FIG. 4 illustrates a jurisdiction rules data structure with version control.

FIG. 5 illustrates contract listing and execution options (order book, RFQ, auction).

FIG. 6 illustrates event data ingestion and integrity scoring.

FIG. 7 illustrates settlement finality with challenge and dispute workflows.

FIG. 8 illustrates adaptive risk controls and kill-switch triggers.

FIG. 9 illustrates market surveillance for spoofing, wash trading, and collusion.

FIG. 10 illustrates tamper-evident audit logging and regulator export.

### DETAILED DESCRIPTION

### Definitions

Event contract: A contract whose payoff depends on whether a defined event occurs by a defined cutoff time, including binary outcomes.
Sports event contract: An event contract whose underlying event is a sports outcome.
Eligibility vector: A computed set of permissions and restrictions for a user, potentially varying by product class and jurisdiction.
Ruleset version: A version identifier for a collection of jurisdiction predicates and product policies used to compute eligibility.
Integrity score: A quantitative value representing confidence in an event outcome based on multi-source evidence and anomaly checks.

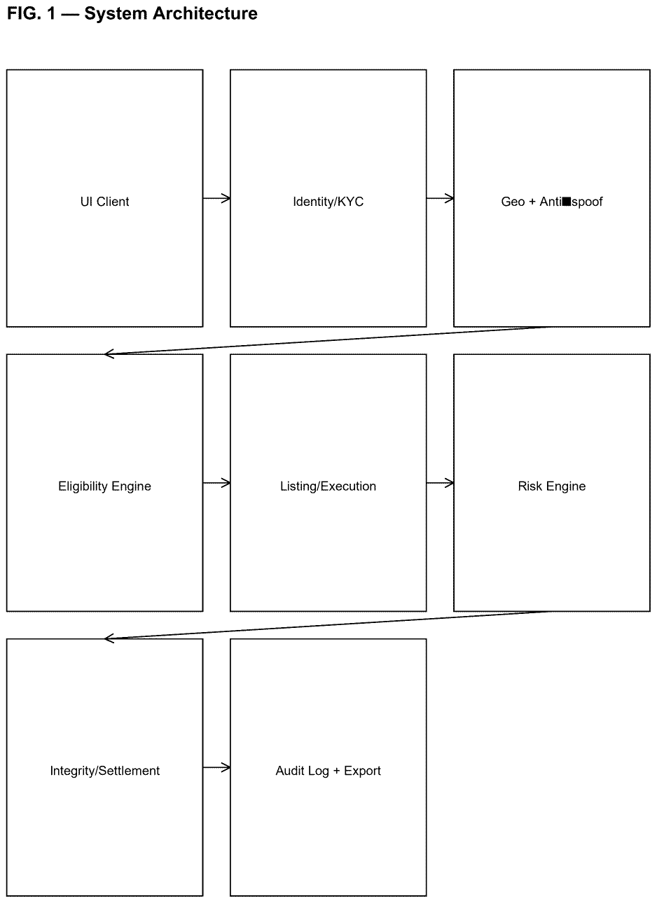

### System Architecture (FIG. 1)

In one embodiment, the platform includes one or more computing devices executing instructions stored on non-transitory media to provide the following modules:
UI Client (mobile/web).
Identity & KYC module.
Geo-location and anti-spoof module.
Eligibility engine with rule evaluation and feature-flagging.
Contract listing engine.
Execution engine (matching, auction, RFQ, or other).
Risk engine (limits, throttles, premium/margin, kill-switch).
Integrity and settlement engine (outcome determination, challenges, disputes, finality).
Market surveillance module (pattern detection, alerting, enforcement).
Audit log and reporting/export interface.

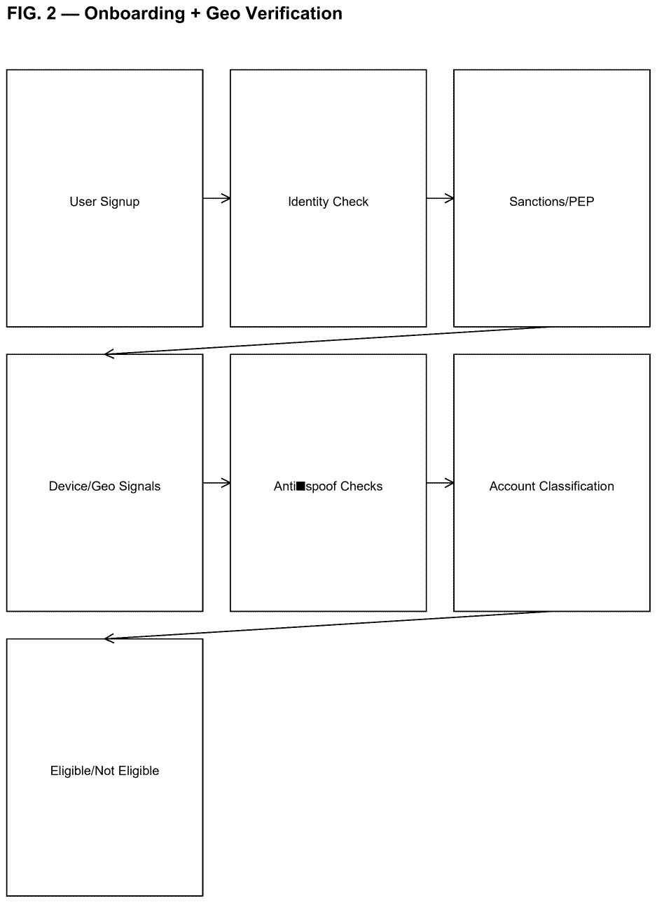

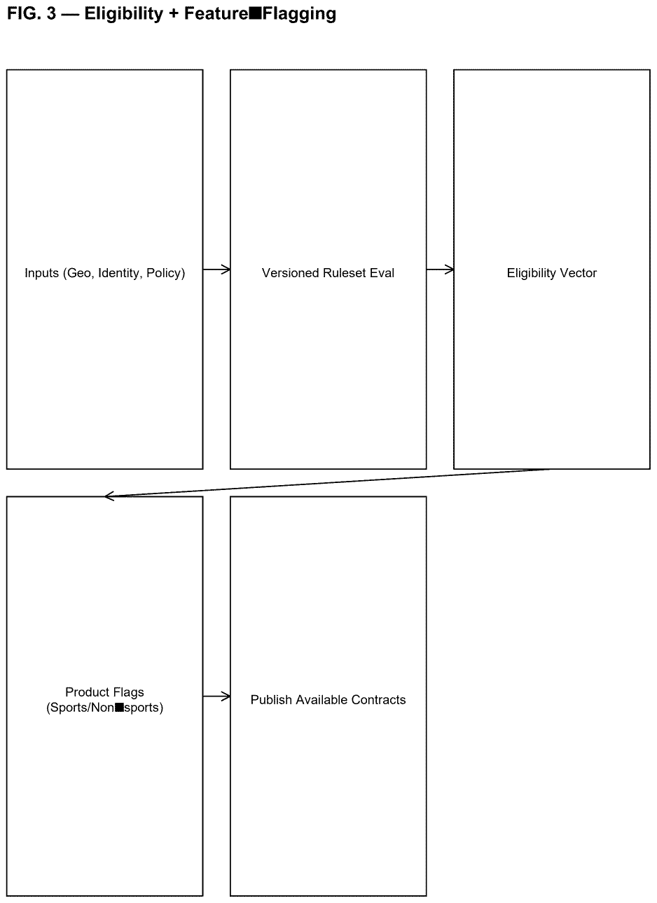

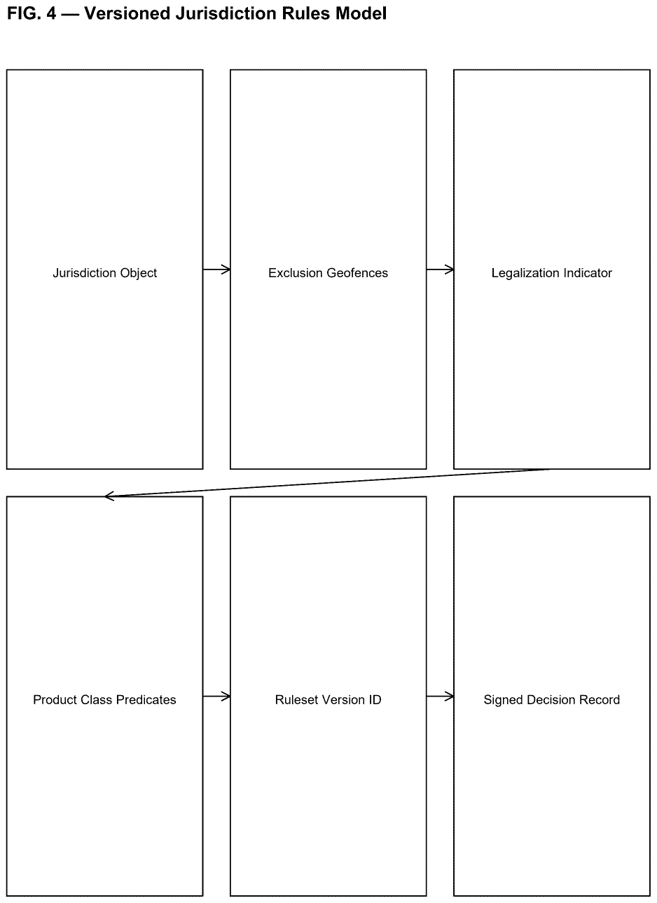

### Eligibility, Geo-Fencing, and Product Switching (FIGS. 2-4)

The eligibility engine determines whether a user may access a product class, including sports event contracts. Eligibility may depend on: (i) physical presence in an allowed jurisdiction; (ii) absence from excluded geo-fences, including sub-jurisdictions; (iii) user identity and account classification; and (iv) a legalization status feed and/or internal policy indicators. Eligibility computations are recorded with ruleset version identifiers to support later reconstruction. In some embodiments, the platform implements automatic product switching, including: (a) enabling sports event contracts in jurisdictions where a predicate indicates sports wagering products are not otherwise legally available; and (b) disabling or sunsetting sports event contracts when the predicate changes (e.g., a legalization indicator changes). Sunsetting may include stopping new listings, preventing position increases, and allowing only risk-reducing actions.

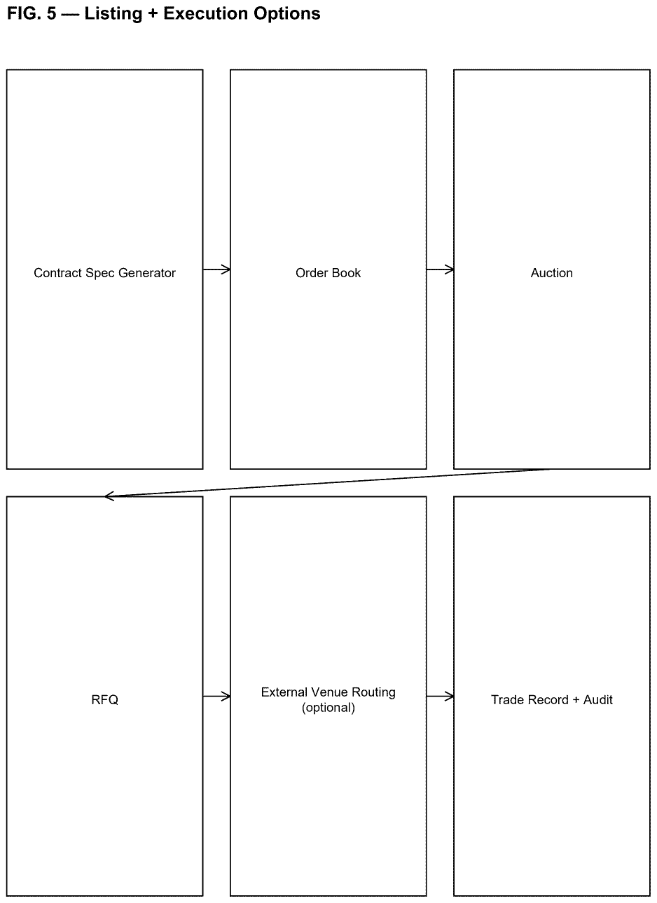

### Contract Listing and Execution (FIG. 5)

The listing engine generates contract specifications including event definition, cutoff time, settlement value(s), tick size, premium/margin requirements, and permitted participant set. Execution may be via central limit order book, periodic auction, RFQ, or other mechanism. The platform may internally execute trades or route orders to an external venue while maintaining eligibility gating, risk limits, and audit logging.

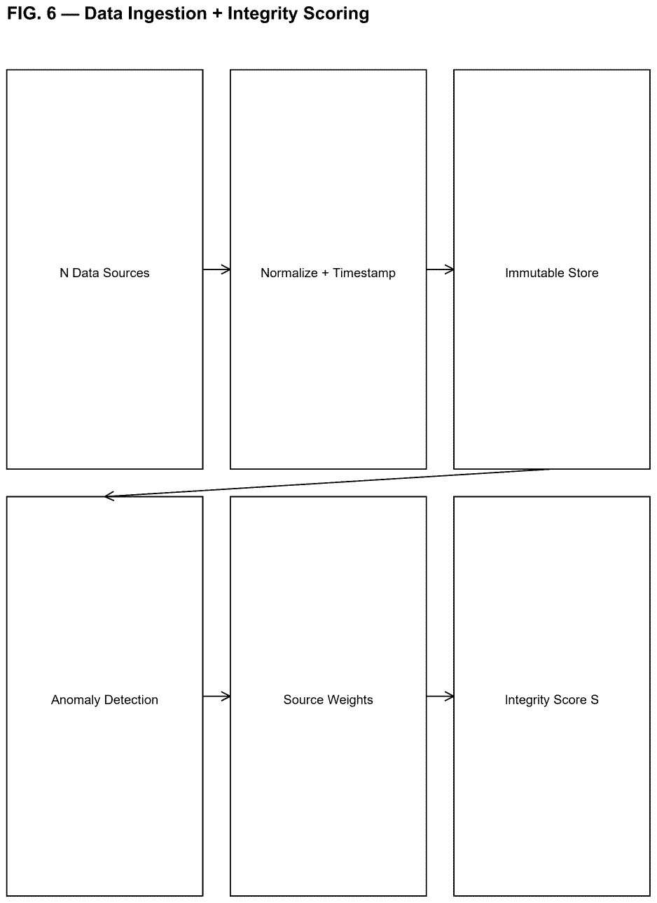

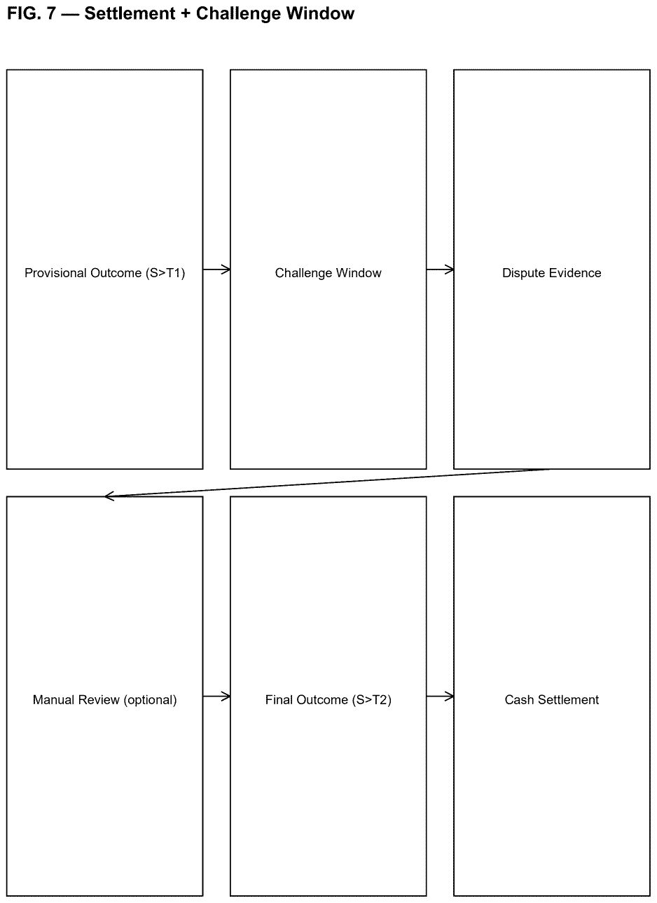

### Integrity Scoring and Settlement (FIGS. 6-7)

The integrity engine ingests event data from multiple independent sources. Each source may be assigned a dynamic reliability weight based on historical accuracy and latency. The system detects anomalies such as conflicting results, late corrections, or suspicious update patterns. An integrity score is computed and compared to thresholds.
1. Ingest event data from N sources; normalize and timestamp; store raw payloads in an immutable store.
2. Compute source confidence values and an aggregate integrity score; record intermediate values.
3. When integrity score exceeds a first threshold, publish a provisional outcome and open a challenge window.
4. During the challenge window, accept disputes from authorized reviewers or automated monitors; optionally require evidentiary payloads.
5. Resolve disputes via additional source ingestion, re-weighting, or manual review; record rationale and decision metadata.
6. When integrity score exceeds a final threshold and the challenge window closes, finalize outcome and settle open positions.

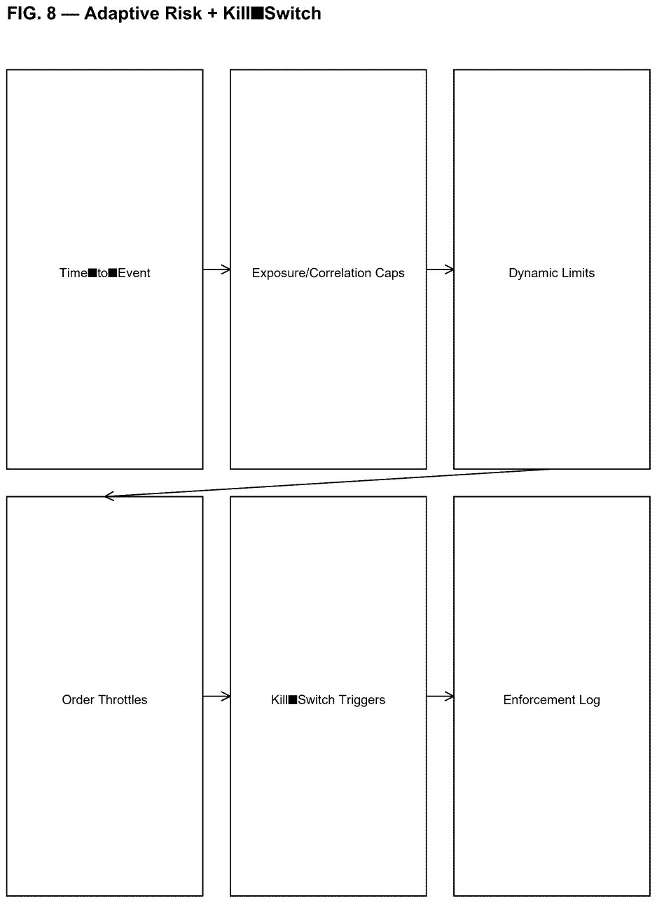

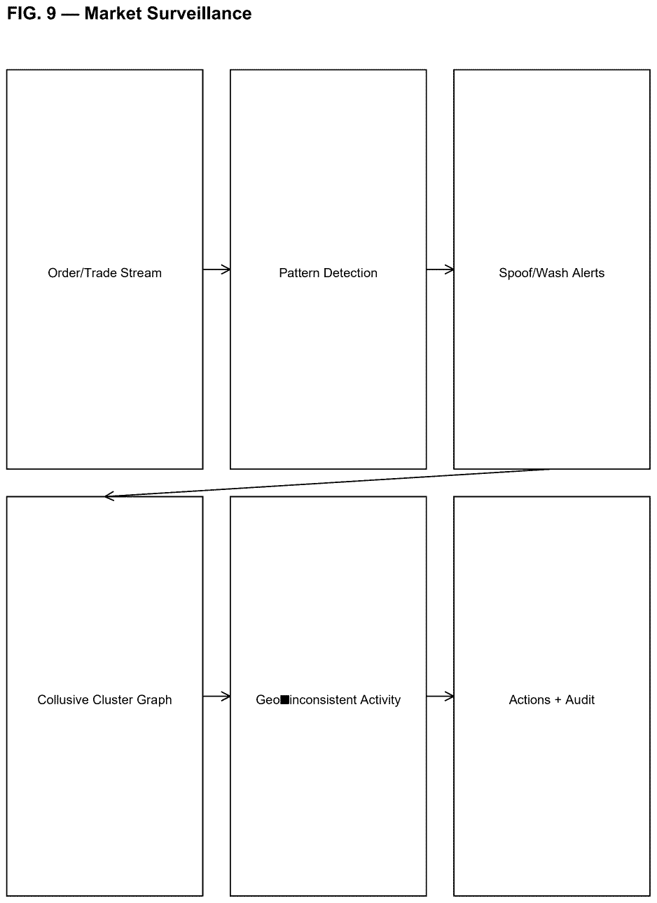

### Risk Controls and Surveillance (FIGS. 8-9)

The risk engine enforces constraints adapted to event contracts. Limits may vary by time-to-event, liquidity, integrity score, user history, and correlated exposure.
Dynamic position and exposure limits that tighten near event start or when integrity score declines.
Correlated exposure caps across contracts referencing the same event or closely linked events.
Order throttling, minimum resting time, or other anti-manipulation constraints.
Automated kill-switch triggers that halt trading for a contract class, jurisdiction, or user segment.
Surveillance alerts for spoofing, wash trading, collusive account clusters, and geo-inconsistent activity; enforcement actions recorded in audit logs.

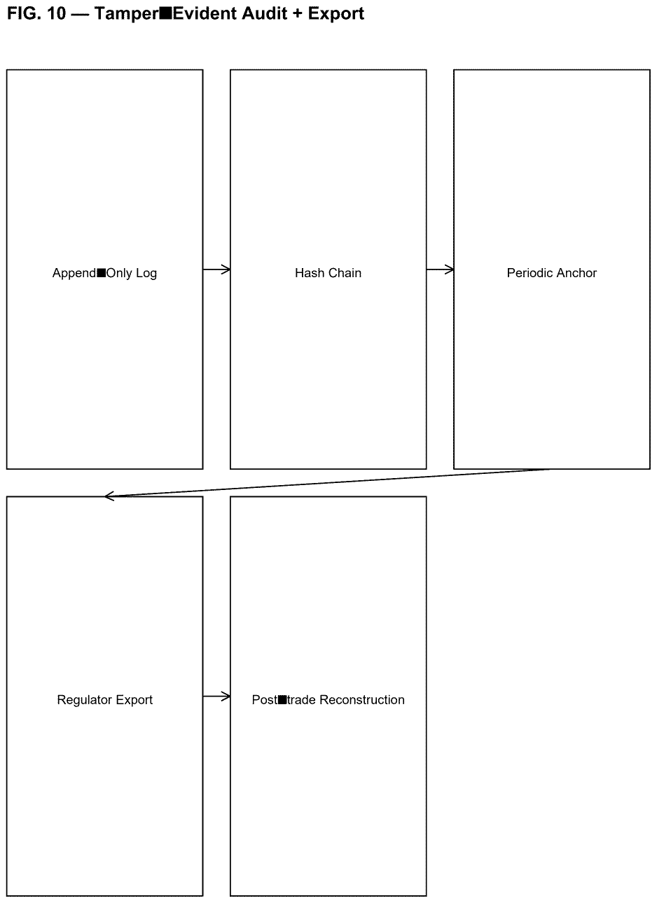

### Audit Logging and Reporting (FIG. 10)

The audit log is append-only and records eligibility decisions (including rule versions), contract listings, orders, trades, settlement events, and administrative actions. In certain embodiments, log entries are hash-chained and periodically anchored to an external immutable timestamping service or blockchain to provide tamper evidence.

A regulator export interface produces datasets sufficient to reconstruct product availability, user eligibility, and trade/settlement history for specified time ranges.

### Optional Blockchain and Tokenization Layer

In some embodiments, the platform additionally supports tokenized sports engagement assets and digital collectibles. Tokenization and NFT issuance may be used for engagement, access, and collectibles, and the event contract platform may use blockchain primarily for auditability and entitlement recordkeeping.

### EXAMPLES

Example 1: A platform offers sports event contracts only in jurisdictions where online sports betting is not otherwise available; non-sports event contracts are offered more broadly. The platform automatically sunsets sports offerings when a legalization status changes.
Example 2: A platform routes execution to a third-party exchange but maintains an independent eligibility overlay, risk overlay, and settlement integrity pipeline.

1-20. (canceled)

21. A computerized system for controlling access to event-contract product classes, the system comprising:
(a) one or more processors; and
(b) non-transitory memory storing instructions that, when executed by the one or more processors, cause the system to:
(i) receive identity information for a user and determine an account classification for the user;
(ii) determine a physical location of the user using one or more geo-location signals and one or more anti-spoof checks;
(iii) evaluate a versioned jurisdiction ruleset comprising jurisdiction predicates for a plurality of event-contract product classes;
(iv) generate, based at least on the account classification, the physical location, the anti-spoof checks, and the jurisdiction predicates, an eligibility vector defining permissions or restrictions for the user by product class;
(v) assign, according to the eligibility vector, an enforcement state for at least one event-contract product class, the enforcement state being selected from enabled, disabled, reduce-only, close-only, unwind, or sunset;
(vi) publish, to the user, only event contracts or product-class actions permitted by the eligibility vector and the enforcement state;
(vii) prevent at least one display, listing, order entry, route, transfer, activation, or position-increasing action when the eligibility vector or the enforcement state indicates non-eligibility; and
(viii) record, in an append-only audit log, an eligibility decision record comprising a user identifier or pseudonymous user identifier, the account classification, a location-confidence value, a ruleset version identifier, a product-class identifier, the enforcement state, a decision code, and a timestamp.

22. The system of claim 21, wherein the versioned jurisdiction ruleset comprises an exclusion geofence for a sub-jurisdiction, venue, reservation, restricted zone, or other defined geographic boundary, and wherein the eligibility vector disables or restricts at least one event-contract product class when the physical location is within the exclusion geofence.

23. The system of claim 21, wherein determining the physical location comprises computing a location-confidence value from at least two geo-location signals selected from GPS data, Wi-Fi data, cellular-network data, IP-address data, device telemetry, network attributes, or operator-provided location evidence.

24. The system of claim 21, wherein the one or more anti-spoof checks comprise detecting a virtual private network, proxy, emulator, remote-desktop session, device-integrity failure, inconsistent network attribute, impossible-travel pattern, or conflict among location signals.

25. The system of claim 21, wherein the versioned jurisdiction ruleset comprises a legalization-status indicator, and wherein the instructions further cause the system to transition the enforcement state for a product class responsive to a change in the legalization-status indicator.

26. The system of claim 25, wherein transitioning the enforcement state comprises preventing new listings or position increases while permitting risk-reducing, close-only, reduce-only, or unwind actions for existing positions.

27. The system of claim 21, wherein preventing at least one display, listing, order entry, route, transfer, activation, or position-increasing action comprises performing pre-display gating or pre-route gating before an order, instruction, or transfer request is transmitted to an execution venue, operator venue, internal matching engine, external venue, or settlement component.

28. The system of claim 21, wherein at least one event-contract product class comprises a non-tokenized event-contract product class, and wherein the eligibility vector is generated and enforced for the non-tokenized event-contract product class without requiring a token identifier.

29. The system of claim 21, further comprising a risk engine configured to set dynamic position limits, exposure limits, order-frequency limits, or throttles based on at least one of time-to-event, integrity score, account classification, product class, enforcement state, correlated exposure, or location-confidence value.

30. The system of claim 29, wherein the risk engine is configured to reject, resize, throttle, hold, or route for manual review a proposed order or action that would cause the user or a linked account group to exceed a dynamic position limit, exposure limit, order-frequency limit, or product-state restriction.

31. The system of claim 21, further comprising a surveillance module configured to generate a surveillance alert for suspected spoofing, wash trading, collusion, multi-accounting, circumvention of jurisdictional restrictions, or coordinated activity involving a plurality of accounts.

32. The system of claim 31, wherein the surveillance module computes a linked-account graph using one or more of shared devices, payment instruments, network attributes, login patterns, location patterns, account-control signals, or behavioral similarity measures.

33. The system of claim 21, further comprising a regulator export interface configured to generate a reconstruction dataset for a specified time interval, the reconstruction dataset comprising ruleset versions, eligibility decision records, location-confidence values, product-class identifiers, enforcement states, decision codes, and timestamps sufficient to reconstruct product availability or access restrictions for the user during the specified time interval.

34. The system of claim 21, wherein the append-only audit log is hash-chained and periodically anchored to an external immutable timestamping service, distributed ledger, blockchain, or other tamper-evident recordkeeping service.

35. The system of claim 21, further comprising a settlement-integrity engine configured to ingest outcome evidence from a plurality of independent sources, compute an integrity score using source-confidence values and anomaly penalties, publish a provisional outcome when a first threshold is satisfied, open a challenge window, and finalize settlement when a finalization criterion is satisfied.

36. The system of claim 21, further comprising a tokenization layer configured for a sports-specific asset class, the tokenization layer comprising:
(i) a token issuance subsystem configured to issue tokens associated with one or more leagues, teams, players, events, esports entities, in-event assets, horse-racing participants, racing stables, racehorses, race events, or combinations thereof;
(ii) a lifecycle state engine configured to maintain a token or virtual asset in one of a plurality of lifecycle states including at least a simulated state, a virtual-asset state, and a blockchain-integrated state;
(iii) a regulatory compliance subsystem configured to evaluate identity, account classification, jurisdictional predicates, and eligibility-vector state before permitting access, transfer, activation, or blockchain integration; and
(iv) an enforcement mechanism configured to prevent access, transfer, activation, or blockchain integration when the eligibility vector indicates non-compliance.

37. The system of claim 36, wherein the instructions further cause the system to record, in the append-only audit log, a lifecycle decision record comprising an asset identifier, asset class, lifecycle state, account classification, ruleset version identifier, eligibility-vector state, compliance decision code, and timestamp.

38. The system of claim 36, wherein the tokenization layer further comprises a dynamic pricing engine configured to adjust token values or token-supply parameters based on multi-dimensional inputs comprising at least two of game statistics, performance metrics, fan sentiment, trading activity, market activity, or external events, and wherein a pricing-adjustment record is stored with a methodology version identifier in the append-only audit log.

39. The system of claim 36, further comprising a digital collectible marketplace configured to facilitate creation, transfer, or resale of non-fungible digital collectibles associated with sports or esports moments, milestones, achievements, race outcomes, or event performances, wherein marketplace access or transfer authorization is controlled according to the eligibility vector and wherein a marketplace transaction record is stored in the append-only audit log.

40. The system of claim 21, wherein at least one event-contract product class comprises a simulated or synthetic product class tied to a real-world event, virtual event, simulated event, or synthetic event representation, and wherein the instructions further cause the system to determine whether the user is authorized to access the simulated or synthetic product class based on account classification, jurisdictional eligibility, and compliance status.

41. The system of claim 40, wherein the instructions further cause the system to determine a settlement state for the simulated or synthetic product class using event outcome evidence or simulation output and record an access decision, settlement state, lane classification, and methodology version identifier in the append-only audit log.

42. A computerized method for controlling access to event-contract product classes, comprising:
(a) receiving identity information for a user and determining an account classification for the user;
(b) determining a physical location of the user using one or more geo-location signals and one or more anti-spoof checks;
(c) evaluating a versioned jurisdiction ruleset comprising jurisdiction predicates for a plurality of event-contract product classes;
(d) generating, based at least on the account classification, the physical location, the anti-spoof checks, and the jurisdiction predicates, an eligibility vector defining permissions or restrictions for the user by product class;
(e) assigning, according to the eligibility vector, an enforcement state for at least one event-contract product class, the enforcement state being selected from enabled, disabled, reduce-only, close-only, unwind, or sunset;
(f) publishing, to the user, only event contracts or product-class actions permitted by the eligibility vector and the enforcement state;
(g) preventing at least one display, listing, order entry, route, transfer, activation, or position-increasing action when the eligibility vector or the enforcement state indicates non-eligibility; and
(h) recording, in an append-only audit log, an eligibility decision record comprising a user identifier or pseudonymous user identifier, the account classification, a location-confidence value, a ruleset version identifier, a product-class identifier, the enforcement state, a decision code, and a timestamp.

43. The method of claim 42, further comprising transitioning the enforcement state for a product class responsive to a change in a legalization-status indicator in the versioned jurisdiction ruleset.

44. The method of claim 42, further comprising setting, by a risk engine, dynamic position limits, exposure limits, order-frequency limits, or throttles based on at least one of time-to-event, integrity score, account classification, product class, enforcement state, correlated exposure, or location-confidence value.

45. The method of claim 42, further comprising controlling access to a token, virtual asset, simulated asset, or blockchain-integrated asset according to the eligibility vector without limiting the plurality of event-contract product classes to tokenized assets.

46. The method of claim 42, further comprising generating, via a regulator export interface, a reconstruction dataset for a specified time interval comprising ruleset versions, eligibility decision records, location-confidence values, product-class identifiers, enforcement states, decision codes, and timestamps.

47. A non-transitory computer-readable medium storing instructions that, when executed by one or more processors, cause the one or more processors to perform operations comprising:
(a) receiving identity information for a user and determining an account classification for the user;
(b) determining a physical location of the user using one or more geo-location signals and one or more anti-spoof checks;
(c) evaluating a versioned jurisdiction ruleset comprising jurisdiction predicates for a plurality of event-contract product classes;
(d) generating, based at least on the account classification, the physical location, the anti-spoof checks, and the jurisdiction predicates, an eligibility vector defining permissions or restrictions for the user by product class;
(e) assigning, according to the eligibility vector, an enforcement state for at least one event-contract product class;
(f) publishing, to the user, only event contracts or product-class actions permitted by the eligibility vector and the enforcement state;
(g) preventing at least one display, listing, order entry, route, transfer, activation, or position-increasing action when the eligibility vector or the enforcement state indicates non-eligibility; and
(h) recording, in an append-only audit log, an eligibility decision record comprising a ruleset version identifier, a product-class identifier, the enforcement state, a decision code, and a timestamp.

48. The non-transitory computer-readable medium of claim 47, wherein the operations further comprise controlling access to at least one simulated, synthetic, virtual, or tokenized product class according to the eligibility vector and recording a corresponding lifecycle-state or settlement-state decision record in the append-only audit log.
